(19) United States
(12) Patent Application Publication
(10) Pub. No.: US 2016/0057368 A1
(43) Pub. Date: Feb. 25, 2016

(54) UNIT PIXEL TIMING CONTROL METHOD OF IMAGING DEVICE HAVING WDR PIXEL ARRAY OF nPD STRUCTURE

(71) Applicant: Clairpixel Co., Ltd., Seongnam-si (KR)

(72) Inventor: Hyuntaek SHIN, Seoul (KR)

(73) Assignee: CLAIRPIXEL CO., LTD., Seongnam-si (KR)

(21) Appl. No.: 14/570,847

(22) Filed: Dec. 15, 2014

(30) Foreign Application Priority Data
Aug. 22, 2014 (KR) 10-2014-0109418

(51) Int. Cl. H04N 5/347; H04N 5/3745

(52) U.S. Cl. CPC H04N 5/347; H04N 5/3745

(57) ABSTRACT

A unit pixel timing control method of an imaging device having a WDR pixel array with an nPD structure is provided. The unit pixel timing control method including the steps of:
causing a reset transistor (RX) to reset a floating diffusion region (FD) when an exposure time of n (where n is a natural number of 2 or greater) photo diodes (PD) of a unit pixel expires; causing a timing generator to supply a first sample and hold pulse (SHR) for outputting a signal corresponding to a reference voltage (Vref) which is a potential of the floating diffusion region; (a) causing a transfer transistor, which is disposed to correspond to one photo diode, to transfer photo-charges accumulated in the photo diode to the floating diffusion region; and (b) causing the timing generator to supply a second sample and hold pulse (SHD) for outputting a signal corresponding to a signal voltage (Vsig) which is a current potential of the floating diffusion region. The steps of (a) and (b) are performed on all of the n photo diodes of the unit pixel.

### BACKGROUND

1. Technical Field

The present invention relates to a unit pixel timing control method of an imaging device having a wide dynamic range (WDR) pixel array with an nPD structure (that is, a structure in which two or more photo diodes are disposed in a pixel).

2. Related Art

One important criterion in quality of an image sensor is a dynamic range indicating the maximum range in which an input signal can be processed without distorting the input signal. The wider dynamic range an image sensor has, the better image can be obtained regardless of a wide variation range in brightness.

However, a color image sensor according to the related art has a demerit that the dynamic range thereof is narrow and thus an original color of an image cannot be expressed well when one more colors of red, green, and blue are saturated.

A method of implementing a wide dynamic range (WDR) pixel bas been proposed for the purpose of overcoming the demerit that the dynamic range is narrow. Examples thereof are disclosed in Korean Patent Application No. 2006-0049806 (Image sensor and Image Processing Method), Korean Patent Application No. 2011-0071734 (Pixel, Pixel Array, Image Sensor Having Same, and Driving Method Thereof), and the like.

However, Korean Patent Application No. 2006-0049806 and Korean Patent Application No. 2011-0071734 disclose a structure for synthesizing a WDR image from a high-exposed image and a low-exposed image which are formed using signals output from photo diodes in a time-divisional manner regardless of the number of photo diodes in a single pixel, and have a problem in that the low-exposed image causes a loss in terms of sensitivity. This is because a low-brightness image can contribute to widening the dynamic range but does not contribute to improvement in brightness.

### SUMMARY OF THE INVENTION

An advantage of some aspects of the invention is to provide a unit pixel timing control method of an imaging device having a WDR pixel array with an nPD structure which can achieve improvement in sensitivity and maintain a WDR function by forming an image using two or more photo diodes of a single pixel together.

Other advantages of the invention will be easily understood from the following description.

This patent application of the invention is a development result in the “Business of Industrial Fusion and Source Technology Development” which is a national research and development business supported by the Ministry of Trade, Industry, and Energy of Korea [10041108, Technology Development of Textile Flexible Platform Integration and Fusion Monitoring System for Safe and Easy Life].

According to an aspect of the invention, there is provided a unit pixel timing control method of an imaging device, including the steps of causing a reset transistor (RX) to reset a floating diffusion region (FD) when an exposure time of n (where n is a natural number of 2 or greater) photo diodes (PD) of a unit pixel expires; causing a timing generator to supply a first sample and hold pulse (SHR) for outputting a signal corresponding to a reference voltage (Vref) which is a potential of the floating diffusion region; (a) causing a transfer transistor, which is disposed to correspond to one photo diode, to transfer photo-charges accumulated in the photo diode to the floating diffusion region; and (b) causing the timing generator to supply a second sample and hold pulse (SHD) for outputting a signal corresponding to a signal voltage (Vsig) which is a current potential of the floating diffusion region, wherein the steps of (a) and (b) are performed on all of the n photo diodes of the unit pixel, and the floating diffusion region is not reset before the corresponding second sample and hold pulse is supplied to each of the n photo diodes.

A wide dynamic range (WDR) image may be generated using output signals output as difference values between the reference voltages of the n photo diodes of the unit pixel and the signal voltage.

One or more of the n photo diodes may have different sizes.

One or more of the n photo diodes may have different exposure times.

The transfer transistors disposed to the respective n photo diodes may transfer photo-charges accumulated in the corresponding photo diodes to the same floating diffusion region.

Other aspects, features, and advantages of the invention will become apparent from the accompanying drawings, the appended claims, and the detailed description.

According to the aspect of the invention, it is possible to achieve improvement in sensitivity and maintain a WDR function by forming an image using two or more photo diodes of a single pixel together.

### BRIEF DESCRIPTION OF THE DRAWINGS

FIG. 1 is a circuit diagram illustrating a unit pixel of a WDR pixel array with a typical nPD structure.

FIG. 2 is a drive timing diagram of an imaging device including a WDR pixel array with an nPD structure according to the related art.

FIG. 3 is a drive timing diagram of an imaging device including a WDR pixel array with an nPD structure according to an exemplary embodiment of the invention.

### DESCRIPTION OF EXEMPLARY EMBODIMENTS OF THE INVENTION

The invention can be modified in various forms and specific embodiments will be described and shown below. However, the embodiments are not intended to limit the invention, but it should be understood that the invention includes all the modifications, equivalents, and replacements belonging to the concept and the technical scope of the invention.

If it is mentioned that an element is “coupled” or “connected” to another element, it should be understood that the element is directly coupled or connected to another element or still another element is interposed therebetween. On the contrary, if it is mentioned that an element is “directly coupled” or “directly connected” to another element, it should be understood that still another element is not interposed therebetween.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Terms, “unit”, “-er(-or)”, “module”, and the like, described in the specification mean a unit for performing at least one function or operation and can be embodied by hardware, by software, or by a combination of hardware and software.

Elements of an exemplary embodiment to be described with reference to the accompanying drawings are not restrictively applied to only the exemplary embodiment, but may be included another exemplary embodiment without departing from the technical idea of the invention. Although particular description is not made, plural embodiments may be embodied as a combined embodiment again.

In describing the invention with reference to the accompanying drawings, like elements are referenced by like reference numerals or signs regardless of the drawing numbers and description thereof is not repeated. When it is determined that detailed description of known techniques involved in the invention makes the gist of the invention obscure, the detailed description thereof will not be made.

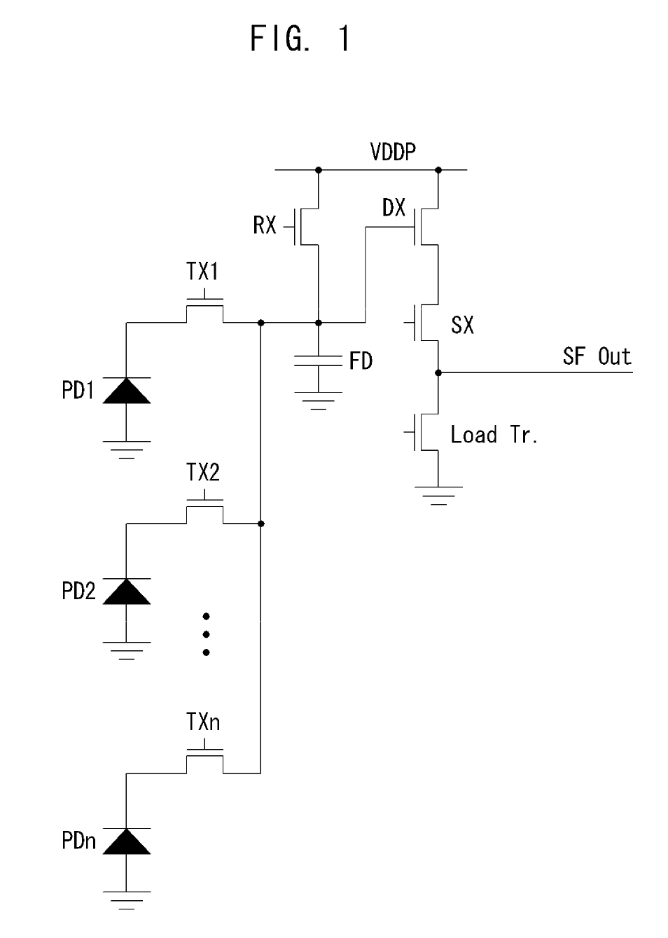

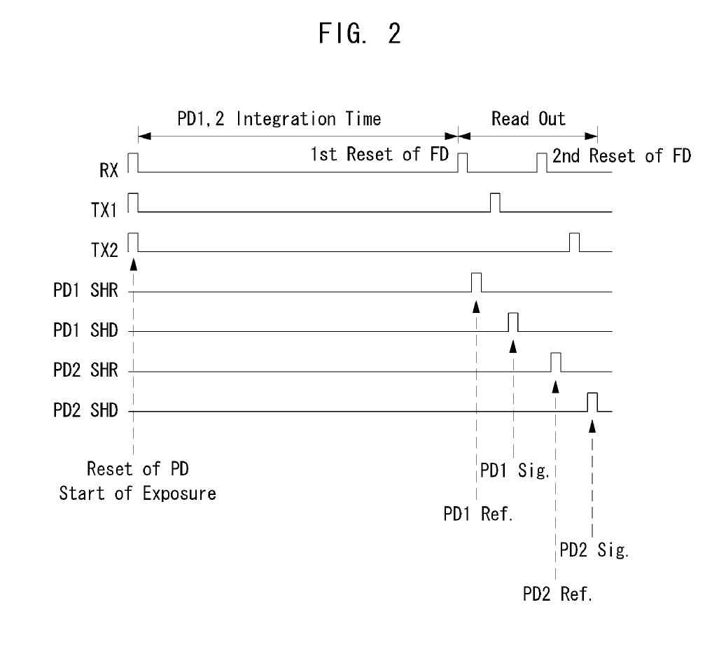

FIG. 1 is a circuit diagram illustrating a unit pixel of a WDR pixel array with a typical nPD structure. FIG. 2 is a drive timing diagram of an imaging device including a WDR pixel array with an nPD structure according to the related art.

Referring to FIG. 1, a unit pixel of a WDR pixel array with an nPD structure includes n (where n is a natural number of 2 or greater) photo diodes (PD) that generate photo-charges in response to light, n transfer transistors (TX) disposed to correspond to the respective photo diodes (PD) so as to transfer the photo-charges accumulated in the photo diodes to a floating diffusion region (FD), a reset transistor (RX) that resets the floating diffusion region (FD) and the photo diodes (PD) by setting the potential of the floating diffusion region (FD) to a desired value and discharging electric charges, a drive transistor (DX) that changes the output voltage of the unit pixel by changing the current of a source-follower circuit depending on an electrode voltage variation of the floating diffusion region, and a selection transistor (SX) that outputs the output voltage of the unit pixel generated by the voltage variation of the floating diffusion region in an analog manner in response to a selection gate signal. A load transistor is disposed outside the unit pixel so as to read an output signal.

The transistors such as the transfer transistors are turned on/off by selection/reset/transfer gate signals, and the gate signals are generated on the basis of pulses supplied from a timing generator (not illustrated). The timing generator may additionally supply sample and hold pulses SHD and SHR to be described later causing a signal corresponding to the potential of the floating diffusion region.

As illustrated in the drawings, two or more photo diodes may be disposed in a single pixel so as to form a WDR image. The exposure times of the photo diodes and/or the sizes of the photo diodes may be equal to or different from each other. Output images may be formed to correspond to the number of photo diodes disposed in each pixel, and a WDR image is synthesized from the output images.

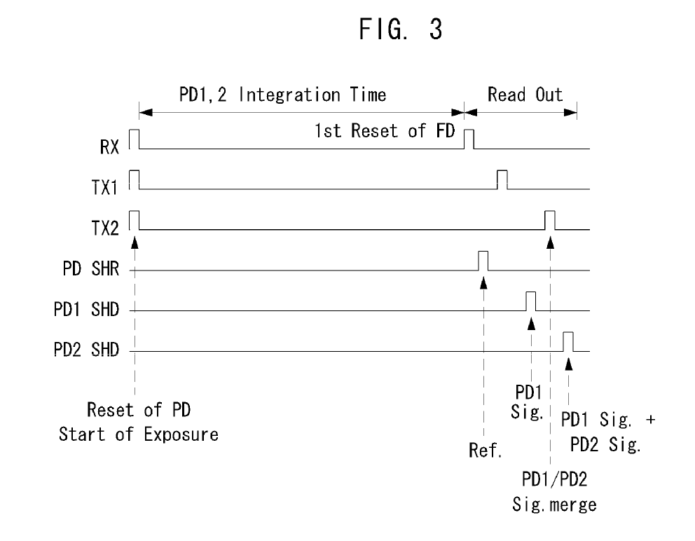

A unit pixel timing control method of an imaging device according to the related art for forming a WDR image will be described below with reference to FIGS. 1 and 3. FIG. 2 is a pixel timing diagram in which it is assumed that two photo diodes are disposed in a single pixel and the exposure times of the first and second photo diodes are equal to each other, but the exposure times and the sizes of the photo diodes may be different from each other.

When the exposure times (integration times) of the first photo diode PD1 and the second photo diode PD2 of a pixel expire, the reset transistor RX resets the floating diffusion region FD and reads the potential of the floating diffusion region as a reference voltage for the first photo diode (PD1 SHR). The sample and hold reference (SHR) illustrated in the drawing means a sampling timing for reading a pixel output and a sampling timing for reading the reference voltage.

Then, the first transfer transistor TX1 transfers photo-charges accumulated in the first photo diode to the floating diffusion region and reads a voltage corresponding to the photo-charges accumulated in the floating diffusion region in reaction to light. The sample and hold data (SHD) illustrated in the drawing means a sampling timing for reading a pixel output and is a sampling timing for reading a voltage in reaction to light.

Thereafter, after the floating diffusion region is reset, the reading of a voltage corresponding to the second photo diode (PD2 SHR), the transferring of photo-charges accumulated in the second photo diode to the floating diffusion region, and the reading of a voltage corresponding to the photo-charges accumulated in the floating diffusion region are performed again.

When the reading of the voltage (SHD) corresponding to the photo-charges accumulated in the first photo diode and the second photo diode is completed, two pieces of output data (that is, output data PD1_Vref−PD1_Vsig based on the first photo diode and output data PD2_Vref−PD2_Vsig based on the second photo diode) may be acquired and synthesized to form a WDR image. Here, Vref represents the pixel output voltage after the floating diffusion region is reset, and Vsig represents the pixel output voltage after the photo-charges generated in the photo diodes are transferred to the floating diffusion region.

One of the two pieces of output data is acquired as a relatively-bright image and the other thereof is acquired as a relatively-dark image. The total brightness of the WDR image depends on the bright image, and the dark image is used to compensate for a saturated region of the bright image.

FIG. 2 illustrates an example in which two photo diodes are disposed in a single pixel. When n photo diodes are disposed in a single pixel, the aforementioned process will be repeated n times and n pieces of output data will be acquired and synthesized to form a WDR image.

FIG. 3 is a drive timing diagram of an imaging device including a WDR pixel array with an nPD structure according to an exemplary embodiment of the invention. FIG. 3 is a pixel timing diagram in which it is assumed that two photo diodes are disposed in a single pixel and the exposure times of the first and second photo diodes are equal to each other, but the exposure times and the sizes of the photo diodes may be different from each other.

The drive timing diagram illustrated in FIG. 3 is different from the drive timing diagram illustrated in FIG. 2, in that the floating diffusion region is not reset in the process on the second photo diode so as to improve sensitivity loss and the SHR is skipped.

That is, when a designated exposure time (integration time) expires, the reset transistor RX resets the floating diffusion region FD and reads the reference voltage Vref for the floating diffusion region at that time (PD SHR).

Subsequently, the first transfer transistor TX1 transfers photo-charges accumulated in the first photo diode to the floating diffusion region, and reads the voltage corresponding to the charges accumulated in the floating diffusion region in reaction to light (PD1 SHD). At this time, the pixel output voltage which had been read and converted into a digital signal can be expressed by Vref−PD1_Vsig.

Thereafter, without resetting the floating diffusion region, the second transfer transistor TX2 transfers photo-charges accumulated in the second photo diode to the floating diffusion region and reads the voltage corresponding to the charges accumulated in the floating diffusion region in reaction to light (PD2 SHD).

Here, since the process of resetting the floating diffusion region is skipped, the voltage corresponding to the charges accumulated in the floating diffusion region is a voltage corresponding to the photo-charges accumulated in the first photo diode and the photo-charges accumulated in the second photo diode. At this time, the pixel output voltage which had been read and converted into a digital signal can be expressed by Vref−(PD1_Vsig+PD2_Vsig).

The aforementioned process can be repeated by the number of photo diodes disposed in a single pixel. The pixel output voltages at the respective timings can be synthesized to generate a WDR signal, and a WDR image can be formed using the WDR signals.

In this way, in the drive timing diagram of an imaging device according to this embodiment, it is possible to acquire a brighter image at the SHD timings corresponding to the respective photo diodes by accumulating the charges collected in the photo diodes in the floating diffusion region for a predetermined exposure time. Accordingly, it is possible to secure a clear image with an increase in sensitivity in a dark environment and to adjust the sensitivity to a certain degree depending on environments.

It is possible to realize a WDR pixel array with an nPD structure which can maintain the WDR function of an image and improve sensitivity thereof by improving only the drive timing without developing a WDR structure with a new nPD structure.

While the invention is described with reference to the embodiments, it will be understood by those skilled in the art that the invention is modified and changed in various forms without departing from the spirit and scope of the invention described in the appended claims.

What is claimed is:

1. A unit pixel timing control method of an imaging device, comprising the steps of:
causing a reset transistor (RX) to reset a floating diffusion region (FD) when an exposure time of n (where n is a natural number of 2 or greater) photo diodes (PD) of a unit pixel expires;
causing a timing generator to supply a first sample and hold pulse (SHR) for outputting a signal corresponding to a reference voltage (Vref) which is a potential of the floating diffusion region;
(a) causing a transfer transistor, which is disposed to correspond to one photo diode, to transfer photo-charges accumulated in the photo diode to the floating diffusion region; and
(b) causing the timing generator to supply a second sample and hold pulse (SHD) for outputting a signal corresponding to a signal voltage (Vsig) which is a current potential of the floating diffusion region,
wherein the steps of (a) and (b) are performed on all of the n photo diodes of the unit pixel, and
wherein the floating diffusion region is not reset before the corresponding second sample and hold pulse is supplied to each of the n photo diodes.

2. The unit pixel timing control method of an imaging device according to claim 1, wherein a wide dynamic range (WDR) image is generated using output signals output as difference values between the reference voltages of the n photo diodes of the unit pixel and the signal voltage.

3. The unit pixel timing control method of an imaging device according to claim 1, wherein one or more of the n photo diodes have different sizes.

4. The unit pixel timing control method of an imaging device according to claim 1, wherein one or more of the n photo diodes have different exposure times.

5. The unit pixel timing control method of an imaging device according to claim 1, wherein the transfer transistors disposed to the respective n photo diodes transfer photo-charges accumulated in the corresponding photo diodes to the same floating diffusion region.
